(19) United States
(12) Patent Application Publication
(10) Pub. No.: US 2018/0145883 A1
(43) Pub. Date: May 24, 2018

(54) SERVER, COMPUTER PROGRAM PRODUCT, AND COMMUNICATION SYSTEM

(71) Applicant: Kabushiki Kaisha Toshiba, Minato-ku (JP)

(72) Inventors: Yu Kaneko, Kawasaki (JP); Toshio Ito, Kawasaki (JP); Masashi Ito, Yokohama (JP)

(73) Assignee: Kabushiki Kaisha Toshiba, Minato-ku (JP)

(21) Appl. No.: 15/680,267

(22) Filed: Aug. 18, 2017

(30) Foreign Application Priority Data
Nov. 24, 2016 (JP) 2016-228077

(51) Int. Cl. H04L 12/24; H04L 12/26; G06F 9/455; G06F 9/50

(52) U.S. Cl. CPC H04L 41/147; H04L 43/08; H04L 67/42; G06F 9/45533; G06F 9/5083; H04L 43/16

(57) ABSTRACT

According to one embodiment, a server manages a resource in a virtual environment used by a service. The server includes a load measurement unit, a load prediction unit, a performance measurement unit, a removing unit, a performance prediction unit, and a resource control unit. The load measurement unit measures a load on the service. The load prediction unit predicts a future load on the service, based on the measured load. The performance measurement unit measures a performance of the service. The removing unit removes influence due to the measured load from the measured performance. The performance prediction unit predicts a future performance of the service, based on the performance from which the influence due to the load has been removed. The resource control unit controls the resource, based on the predicted load and the predicted performance.

### CROSS-REFERENCE TO RELATED APPLICATIONS

This application is based upon and claims the benefit of priority from Japanese Patent Application No. 2016-228077, filed on Nov. 24, 2016; the entire contents of which are incorporated herein by reference.

### FIELD

An embodiment described herein relates generally to a server, a computer program product, and a communication system.

### BACKGROUND

Cloud computing is widespread. One of implementations of the cloud computing is a public cloud. The public cloud may be implemented by a virtual environment such as a virtual machine (VM). A method called “VM scaling” for controlling the number of VMs used is well studied. For example, a technique is known in which changes in response time of a system are monitored, and the number of VMs is increased when the response time tends to increase and the number of VMs is reduced when the response time tends to decrease.

However, in such a conventional technique, there is a problem in that accuracy of predicting the number of required VMs is low and a situation is more likely to occur in which a performance target of response time cannot be achieved.

### BRIEF DESCRIPTION OF THE DRAWINGS

FIG. 1 is a block diagram of a communication system according to the present embodiment;

FIG. 2 is a block diagram of a management server;

FIG. 3 is a diagram illustrating a data structure of information stored in a load history storage unit;

FIG. 4 is a diagram illustrating a data structure of information stored in the load history storage unit;

FIG. 5 is a diagram illustrating one example of a relation between external load and response time;

FIG. 6 is a diagram illustrating a data structure of information stored in a performance history storage unit;

FIG. 7 is a flowchart of resource control processing;

FIG. 8 is a flowchart of calculation processing for VM count; and

FIG. 9 is a hardware configuration diagram of a server.

### DETAILED DESCRIPTION

According to one embodiment, a server manages a resource in a virtual environment used by a service. The server includes a load measurement unit, a load prediction unit, a performance measurement unit, a removing unit, a performance prediction unit, and a resource control unit. The load measurement unit measures a load on the service. The load prediction unit predicts a future load on the service, based on the measured load. The performance measurement unit measures a performance of the service. The removing unit removes influence due to the measured load from the measured performance. The performance prediction unit predicts a future performance of the service, based on the performance from which the influence due to the load has been removed. The resource control unit controls the resource, based on the predicted load and the predicted performance.

A preferred embodiment of a server according to the present invention will now be described in detail with reference to the attached drawings.

A public cloud using VMs is used as follows, for example. A user sends a request to generate a VM to a public cloud provider. The VM is a virtual computer that is implemented by software. The public cloud provider selects, from among a physical machine (PM) group that the provider has, a PM in which a VM is to be generated, and generates the VM. On the VM, the user can execute an application prepared by the user. The user pays a usage fee for the VM to the provider. The usage fee is determined based on the number of used VMs, running time of the VM, and communication charges of the VM, for example. The user can eliminate an unnecessary VM.

In a system (e.g., a system configured with a plurality of applications) that the user implements using the public cloud, a performance requirement is defined. For example, for a web application system, “response time” is set as the performance requirement. In order to satisfy the performance requirement, the user tries to generate a required minimum number of VMs each having a required minimum performance. This is because such trial leads to reduction in usage fee for the VMs.

The performance of a system implemented by the user is not always constant. For example, in a web application system, as the number of requests to the system per second increases, the performance decreases. Because the number of requests per second is not constant, the performance of the system varies. Consequently, a time period when the performance requirement cannot be satisfied may occur.

In the public cloud, VMs of different users may run on the same PM. For example, a VM of a user A and a VM of a user B may run on the same physical machine. In this case, the performance of an application of the user A and the performance of an application of the user B interfere with each other. The user A and the user B do not know the load characteristics of each other's applications. This also becomes one of the variation factors in the performance of the system.

Furthermore, because of convenience of the public cloud provider, a VM of a user may be moved to another PM without notifications. Movement of the VM between PMs can be accomplished by a technique called “live migration”. The performance of the VM during the movement decreases. This also becomes one of the variation factors in the performance of the system.

Hereinafter, the outside of the public cloud is considered “external” and the inside of the public cloud is considered “internal”, and a load on the system caused by an external unit of the system is called “external load”. A load on the system caused by an internal unit of the system is called “internal load”. For example, a request to the system is one example of the “external load”. Processing of a VM of another user and live migration of the VM are examples of the “internal load”.

The VM scaling described above is used, for example, to reduce the usage fee for a VM while reducing the time period when the performance requirement cannot be satisfied. In a conventional VM scaling, a “response time” that is an index of performance of a system is used as time-series data to predict variation in the data and, based on the prediction result, the VM count is increased or reduced. In such a technique, the response time is predicted without differentiating between the “external load” and the “internal load”, so that the accuracy of predicting the required VM count may be low.

In general, when the time-series data is predicted, resolving the time-series data provides a higher accuracy in prediction. This is because, by the resolving, noises in the time-series data can be removed, and also prediction algorithms optimum for individual pieces of time-series data can be used.

In view of this, in the present embodiment, in a communication system using a virtual environment such as a public cloud, the external load and the internal load are differentiated from each other and are considered to predict the performance of the system, and based on the prediction result, resources in the virtual environment are controlled. This provides a higher accuracy in predicting the performance of the system than with the conventional technique. This also enables the resources to be appropriately adjusted, whereby the performance of the system can be stabilized.

When a public cloud, for example, is used, there may be a situation in which the internal load cannot be measured because providers are different, for example. In view of this, in the present embodiment, performance under a condition in which the internal load does not exist is obtained in advance, and based on this performance and a measured value of performance including influence of the external load, performance having only a variation component due to the internal load is calculated.

The following describes, as an example, a communication system including a public cloud (one example of an information processing system) and a management server (one example of a server) configured to manage a virtual environment (e.g., a VM) using the public cloud. The information processing system is not limited to the public cloud, and may be any type of system that is a system configured to provide a service using a virtual environment. The VM is one example of the virtual environment, and the present embodiment can be applied to a virtual environment other than the VM, such as a container.

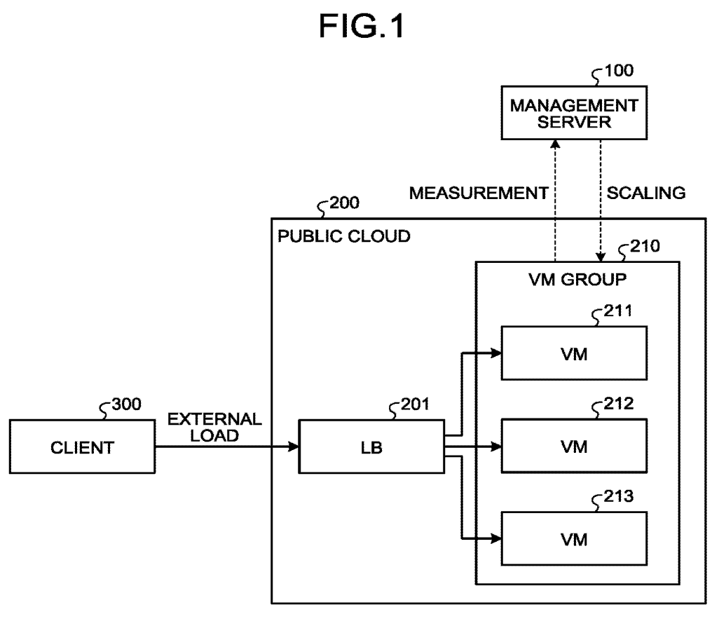

FIG. 1 is a block diagram illustrating a configuration example of the communication system according to the present embodiment. As depicted in FIG. 1, the communication system according to the present embodiment includes a management server 100 as the server, a public cloud 200 as the information processing device, and a client 300.

The public cloud 200 includes a load balancer (LB) 201 and a VM group 210. The VM group 210 includes a plurality of VMs 211, 212, and 213. The number of the VMs is not limited to three, and may be any numbers. On each VM, any application operates. In the client 300, another application, for example, that is used by accessing an application operating on each VM operates.

The following describes, as an example, a case in which a web application server (WebAS) operates on each VM and a web browser operates in the client 300.

The client 300 (web browser) transmits a Hypertext Transfer Protocol (HTTP) request to a WebAS on a VM, for example. This HTTP request is assumed to be an external load.

The LB 201 functions so as to balance loads of the respective WebASs. In other words, the LB 201 functions as a load distributing unit configured to distribute loads on the respective VMs. The function of the LB 201 may be provided as a service by a public cloud provider 200, or may be implemented by a user of a VM for oneself. The LB 201 receives the HTTP request from the client 300, determines to which WebAS the request is to be forwarded, and forwards the request. A procedure to determine this forwarding address may be any method. For example, the LB 201 determines the forwarding address of the HTTP request such that loads of the respective WebASs are balanced.

The following describes functions of the management server 100 in detail. The management server 100 measures both of an HTTP request (external load) sent to each application (WebAS in the present embodiment) and the performance of the application. In the present embodiment, the management server 100 removes a performance variation component due to the external load from the measured performance of the application, and uses the performance from which the variation component has been removed to predict the required VM count.

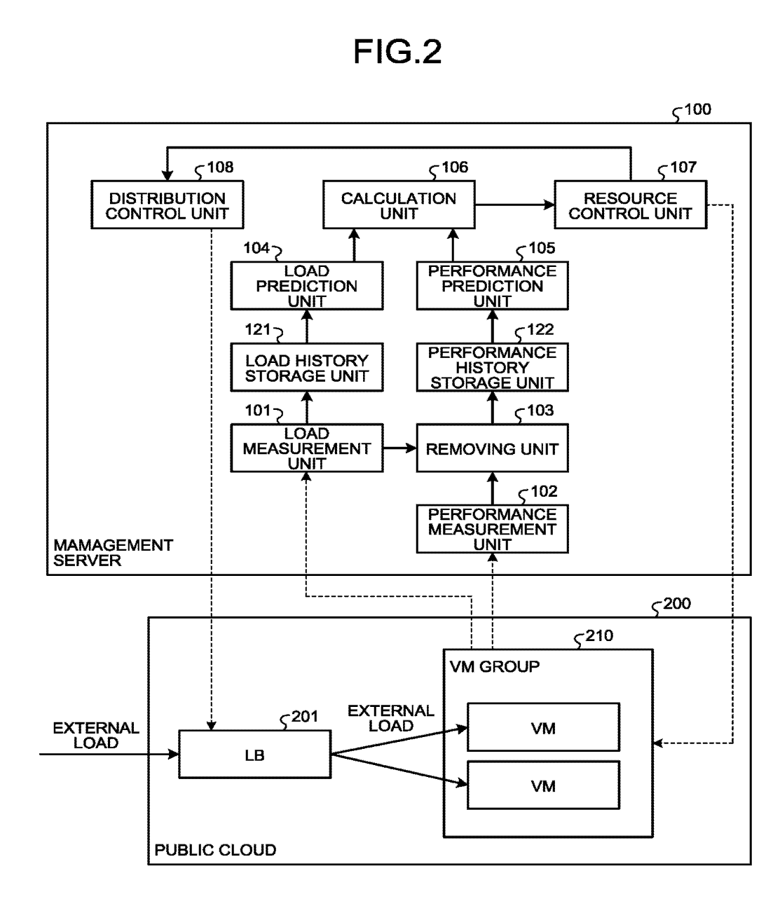

FIG. 2 is a block diagram illustrating one example of an internal configuration of the management server 100. As depicted in FIG. 2, the management server 100 includes a load measurement unit 101, a performance measurement unit 102, a removing unit 103, a load history storage unit 121, a load prediction unit 104, a performance history storage unit 122, a performance prediction unit 105, a calculation unit 106, a resource control unit 107, and a distribution control unit 108.

The load measurement unit 101 measures loads on services provided by the public cloud. For example, the load measurement unit 101 measures an external load (HTTP request) every unit time. For example, if measurement is performed every one second, the external load is the number of HTTP requests (requests per second (RPS)) generated for one second. As a measuring method, for example, a method of counting the number of HTTP requests received by each WebAS can be used. By this method, the RPS can be calculated, and thus the load measurement unit 101 can acquire the RPS from each WebAS. The method of measuring the external load is not limited to this, and any method can be used. For example, the external load may be measured in consideration of the size or the like of each request.

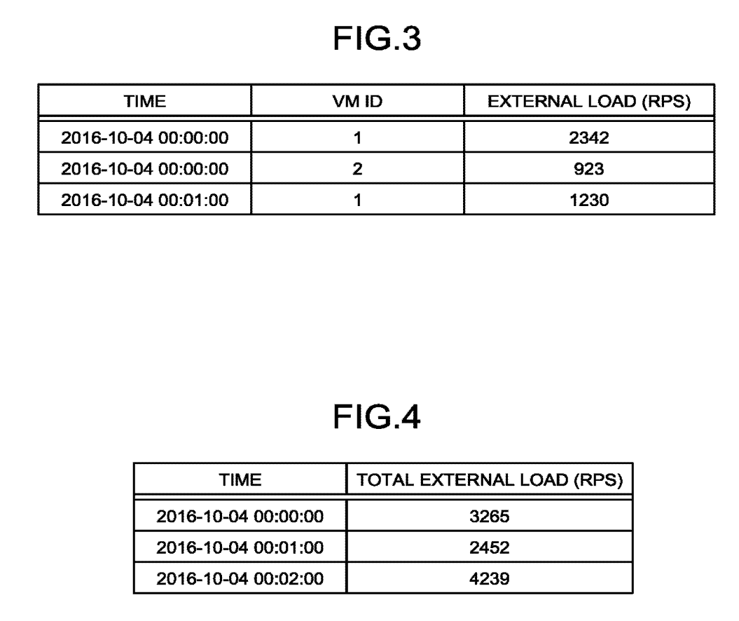

The load history storage unit 121 stores therein the measured loads. FIG. 3 is a diagram illustrating one example of a data structure of information stored in the load history storage unit 121. As depicted in FIG. 3, for example, the load history storage unit 121 stores therein measured external loads together with pieces of identification information of VMs (VM IDs) and pieces of time information. With these pieces of information, the external loads form time-series data.

The load history storage unit 121 sums external loads generated in all VMs, and stores therein the sums (total external loads) together with the pieces of time information. FIG. 4 is a diagram illustrating one example of a data structure of the information thus stored. These pieces of information also form time-series data.

Based on the measured loads, the load prediction unit 104 predicts future loads on the services. For example, the load prediction unit 104 uses the external loads stored in the load history storage unit 121 to predict the future external loads. The load prediction unit 104 predicts both of an external load on each VM and an external load on all VMs. A method of prediction performed by the load prediction unit 104 may be any method. For example, a method of using a moving average as a predicted value, a method of prediction using an autoregressive moving average, and other methods can be used. Depending on variation characteristics of the external loads, an appropriate prediction method may be selected.

How far in the future predictions are to be made and the unit of the predictions may be freely determined. For example, predictions may be made every one second until one minute later, or predictions may be made every one minute until 10 minutes later. In some methods, a period of time required to start up each VM is considered. In other words, the load prediction unit 104 may predict loads after a period of time required to start up the VM has elapsed from the current time. For example, it may take several ten seconds to several minutes from when a “request to generate a VM” is transmitted to the public cloud 200 to when generation of the VM is completed. If periods of time taken for the generation of the respective VMs have been measured and stored during a process of operating the management server 100, the load prediction unit 104 can calculate the average of the periods of time taken for the generation of the VMs. The load prediction unit 104 may predict external loads at the time obtained by adding the calculated average to the current time.

The performance measurement unit 102 measures the performances of the services. For example, the performance measurement unit 102 measures the performance of each application every unit time. When a WebAS is used as the application, the performance measurement unit 102 measures the average of response times per unit time, for example, as the performance of the WebAS. The response time is a period of time from when a WebAS receives an HTTP request to when the WebAS returns an HTTP response. For example, when the performance is measured every one second, the performance measurement unit 102 measures, as the performance, the average of response times for the respective HTTP requests received for one second. When the number of WebASs (VMs) is five, five measured values are obtained every unit time.

The removing unit 103 removes influence (variation components due to external loads) of the loads measured by the load measurement unit 101 from the performances measured by the performance measurement unit 102. Consequently, the obtained performances become performances having only variation components due to internal loads.

In the present embodiment, in order to remove the variation components due to external loads, the following pieces of information under an environment in which internal loads do not exist are grasped in advance.
The maximum amount of external load that can be processed per unit time
The relation between external load and performance

These pieces of information can be grasped by preparing a PM having the same performance as that of a VM that is planned to be generated in the public cloud 200 and conducting a simple evaluation test. When a PM for the evaluation test is selected, the performance of physical resources thereof such as a central processing unit (CPU) and a memory is preferably equivalent to that of the VM planned to be generated.

For example, the user only needs to execute, on a prepared PM, a WebAS that is planned to be executed on the public cloud 200, transmit HTTP requests in accordance with various transmission rates (RPS) to the WebAS, and measure the response time. This enables the user to grasp the maximum amount of external load (RPS) that can be processed per unit time. Hereinafter, this “maximum amount of RPS that can be processed per unit time” is called “MaxRPS”. This MaxRPS is a value obtained by evaluation under an environment in which internal loads do not exist. Thus, the performance of the WebAS executed on the public cloud 200 in which internal loads exist becomes equal to or lower than the MaxRPS.

Through the evaluation test, a large number of combinations of (RPS, response time) are obtained. By applying linear regression analysis, for example, to this combination group, the relation between external load (RPS) and performance can be formulated as the following formula (1). This formula represents the relation between RPS and response performance under a condition in which internal loads do not exist in the public cloud 200 (ideal condition in which only external loads exist). The formula (1) thus obtained is imparted to the removing unit 103 in advance.

Response time=f(RPS) (1)

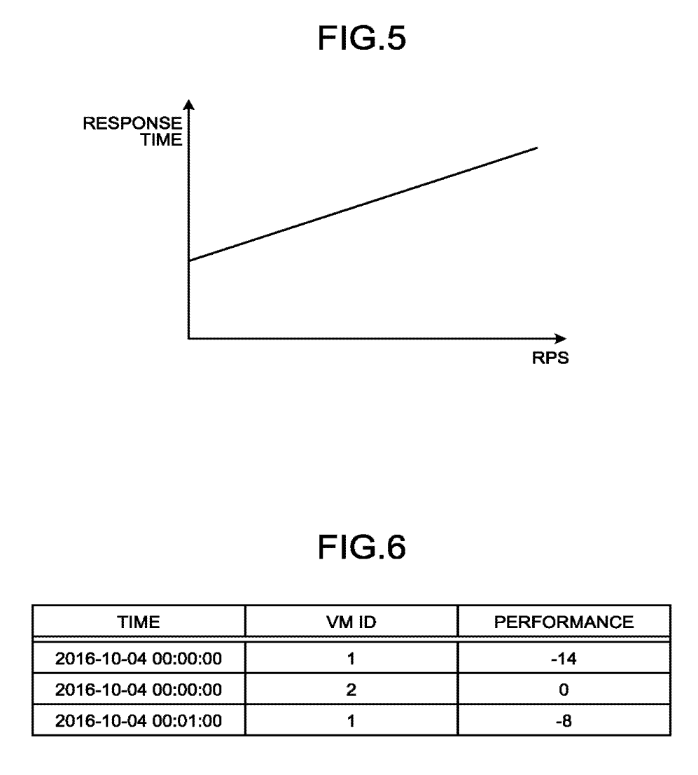

FIG. 5 is a diagram illustrating one example of the relation between external load (RPS) and response time. FIG. 5 illustrates an example in which there is a linear relation between the RPS and the response time.

The removing unit 103 uses the formula (1) and the external loads measured by the load measurement unit 101 to remove the variation components due to the external loads from the performances measured by the performance measurement unit 102. For example, the removing unit 103 receives a measured value RPS1 of an external load (RPS) on a certain VM (called “VM1”) during a certain unit time T1 from the load measurement unit 101. The removing unit 103 receives an average rt1 of response times of a WebAS of the VM1 during the unit time T1 from the performance measurement unit 102. The removing unit 103 substitutes the RPS1 into the formula (1) to obtain a response time rt2. The removing unit 103 then calculates a performance from which a variation component due to the external load is removed based on the following formula (2).

Performance=rt2−rt1 (2)

The formula (2) can be considered to be a formula for calculating a reduction level of performance due to an internal load.

The performance history storage unit 122 stores therein the performances from which the variation components have been removed. FIG. 6 is a diagram illustrating one example of a data structure of information stored in the performance history storage unit 122. As depicted in FIG. 6, for example, the performance history storage unit 122 stores therein performances calculated by the formula (2) together with IDs of VMs and pieces of time information. Consequently, the performances of applications are stored as time-series data under a condition in which the variation components due to external loads have been removed.

Based on the performances from which influence of the loads has been removed, the performance prediction unit 105 predicts future performances of the services. For example, the performance prediction unit 105 uses the performances stored in the performance history storage unit 122 to predict the future performances of applications (app performances). Specifically, the app performances are predicted for the respective VMs.

Similarly to the load prediction unit 104, a method of prediction performed by the performance prediction unit 105 may be any method. For example, a method of using a moving average as a predicted value, a method of prediction using an autoregressive moving average, and other methods can be used. Depending on variation characteristics of the performances, an appropriate prediction method may be selected.

Similarly to the load prediction unit 104, how far in the future predictions are to be made and the unit of the predictions may be freely determined. For example, the performance prediction unit 105 may predict performances after a period of time required to start up the VM has elapsed from the current time. The time to predict the performances in the future and the unit of the prediction are preferably the same as those in the case of the load prediction unit 104.

The calculation unit 106 calculates the required VM count in the future on the basis of the prediction result of the external loads and the prediction result of the app performances. The method of calculating the VM count will be described later in detail.

The resource control unit 107 controls a resource in accordance with determination of the calculation unit 106. For example, the resource control unit 107 generates a VM and stops a VM in accordance with the determination of the calculation unit 106. When increasing the number of VMs, the resource control unit 107 may generate a VM and install a WebAS thereon. Alternatively, an image of a VM on which a WebAS has been installed may be stored as a template in advance, and the resource control unit 107 may use the template to generate the VM. The resource control unit 107 notifies the distribution control unit 108 that control of the VM count has been completed.

The resource to be controlled is not limited to the number of VMs (VM count). When a container is used as a virtual environment, at least one of the number of VMs and the number of containers may be controlled. Physical resources such as a CPU and a memory that are allocated to VMs (containers) may be controlled.

The distribution control unit 108 transmits information on VMs controlled by the resource control unit 107 to the LB 201 to control load distribution processing performed by the LB 201. For example, when the number of VMs has increased, the distribution control unit 108 notifies the LB 201 about the ID and the Internet Protocol (IP) address of a newly added VM. When the number of VMs has decreased, the distribution control unit 108 notifies the LB 201 about the ID and the IP address of a stopped VM. By these notifications, the LB 201 can determine a forwarding address for an HTTP request such that the loads on the respective VMs are balanced.

The load measurement unit 101, the performance measurement unit 102, the removing unit 103, the load prediction unit 104, the performance prediction unit 105, the calculation unit 106, the resource control unit 107, and the distribution control unit 108 may be implemented by, for example, causing one or more processing circuits such as a CPU to execute a program, that is, by software, or may be implemented by hardware such as one or more integrated circuits (IC), or may be implemented by a combination of software and hardware.

The load history storage unit 121 and the performance history storage unit 122 may be configured with any commonly used storage medium such as a hard disk drive (HDD), an optical disk, a memory card, or a random access memory (RAM).

The following describes one example of a method of calculating the VM count by the calculation unit 106. The total external load predicted by the load prediction unit 104 is written as f_load_all. This f_load_all is expressed as follows.

f_load_all=((t1,load_all(t1)),(t2,load_all(t2)), . . . ,(tN,load_all(tN)))

Herein, load_all(t) is a predicted value of the total external load at time t. N is an integer of one or more. If the total number of VMs in operation is M, the maximum value of external loads that can be processed by all VMs is M×MaxRPS. The calculation unit 106 calculates for each time t (from t1 to tN) to verify whether the following formula (3) holds.

load_all(t)>M×MaxRPS (3)

If the formula (3) holds, even when there is no internal load, the current VM group 210 cannot process all of the external loads. It is assumed that the number of pieces of t is P when the formula (3) holds. If P exceeds a predetermined threshold, or if the ratio of P to N exceeds a predetermined threshold, the calculation unit 106 determines that the number of VMs needs to be increased. The calculation unit 106 may determine that “the number of VMs needs to be increased if the formula (3) has been satisfied even once”, for example.

Various methods may be used to determine the number of VMs that is to be increased at one time. For example, a method may be used in which the number is increased one by one every time. When it is determined based on the formula (3) that the number of VMs needs to be increased, the number of VMs to be increased may be calculated by the following formula (4).

VM count to be increased=ceil(max(t,abs(load_all(t)−(M×MaxRPS)))/MaxRPS)+α (4)

Herein, abs(x) is the absolute value of x, max(t,x) is the maximum x with respect to all pieces of t, and ceil(x) is a value obtained by rounding up x. In other words, based on the formula (4), the calculation unit 106 selects a maximum value from differences between predicted values of external loads and external loads that can be processed by the VM group 210, divides the selected maximum value by MaxRPS, and rounds up the quotient. The calculation unit 106 sets a value obtained by adding a variable α (an integer of zero or more) for fine adjustment to the result, as the number of VMs to be increased.

The calculation unit 106 also calculates the VM count to be increased or reduced when internal loads are considered. An app performance predicted by the performance prediction unit 105 is written as f_perf(i). Herein, i is an ID of a VM. This f_perf(i) is expressed as follows.

f_perf(i)=((t1,perf_i(t1)),(t2,perf_i(t2)), . . . ,(tN,perf_i(tN)))

The calculation unit 106 calculates to verify whether the following formula (5) holds at each time t (from t1 to tN) and for each VM_i.

f(load_all(t)/M)−perf_i(t)>threshold of response time (5)

Herein, f is the formula (1), and f(load_all(t)/M) is a response time that is predicted based on external loads on discrete VMs when internal loads are not considered. This response time is corrected by the app performance prediction result (perf_i(t)).

When the formula (5) holds, the response time by the WebAS of the VM_i exceeds an acceptable range. The threshold of the response time is determined in advance. The threshold of the response time is 100 milliseconds, for example.

The calculation unit 106 sets the number of pieces of t at which the formula (5) holds as Q. If Q exceeds a predetermined threshold, or if the ratio of Q to N exceeds a predetermined threshold, the calculation unit 106 increases the number of VMs. For example, the calculation unit 106 may determine that “the number of VMs needs to be increased if the formula (5) has been satisfied even once”. When temporary reduction in performance is allowable, the calculation unit 106 may determine that “the number of VMs needs to be increased if the ratio of Q to N exceeds 0.5”.

If it is determined based on the formula (5) that the number of VMs needs to be increased, the calculation unit 106 finds the minimum M′ that satisfies the following formula (6), and sets (M′−M) as the number of VMs to be added.

f(load_all(t)/M′)−perf_i(t)≤threshold of response time (6)

After having found M′, the calculation unit 106 sets this M′ as a new M for another VM to calculate the formula (5). This enables the number of VMs to be prevented from being unnecessarily increased.

Meanwhile, the calculation unit 106 studies the possibility of being able to reduce the number of VMs. The calculation unit calculates to verify whether the following formula (7) holds at each time t (from t1 to tN) and for each VM_i.

f(load_all(t)/M″)−perf_i(t)≤threshold of response time (7)

In the formula (7), M″ is an integer that is smaller than M. For example, M″=M−1. If the formula (7) holds for all “combinations of time t (from t1 to tN) and VM_i”, the calculation unit 106 reduces the VM count. In this case, the reduced number of VMs is (M−M″).

If the formula (3), the formula (5), and the formula (7) do not hold, the calculation unit 106 determines that the number of VMs does not have to be changed.

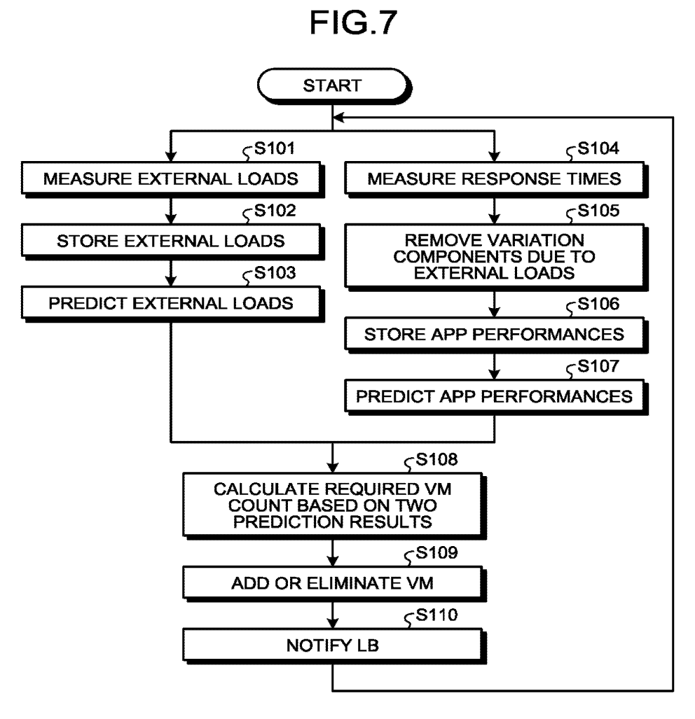

The following describes resource control processing performed by the management server 100 configured as described above according to the present embodiment with reference to FIG. 7. FIG. 7 is a flowchart illustrating one example of the resource control processing in the present embodiment.

At certain time t, the load measurement unit 101 measures external loads (step S101). The measured external loads on the respective VMs are sent to the removing unit 103. The load history storage unit 121 stores therein external loads on the respective VMs, and the total external load obtained by summing the external loads on the respective VMs (step S102). Based on information thus stored, the load prediction unit 104 predicts external loads (step S103).

Similarly, at the certain time t, the performance measurement unit 102 measures response times (step S104). The removing unit 103 removes variation components due to external loads from the measured response times (step S105). The performance history storage unit 122 stores therein the removal results as app performances (step S106). The performance prediction unit 105 predicts app performances (step S107).

Based on the prediction result of the external loads and the prediction result of the app performances, the calculation unit 106 calculates the VM count to be increased or reduced (step S108). Calculation processing for calculating the VM count to be increased or reduced will be described later in detail. The calculation result is sent to the resource control unit 107. Based on the calculation result, the resource control unit 107 actually increases or reduces the number of VMs (step S109). The resource control unit 107 notifies the LB 201 about information indicating the number of VMs to be increased or reduced via the distribution control unit 108 (step S110). Based on this notification, the LB 201 reflects the information to the subsequent load distribution processing.

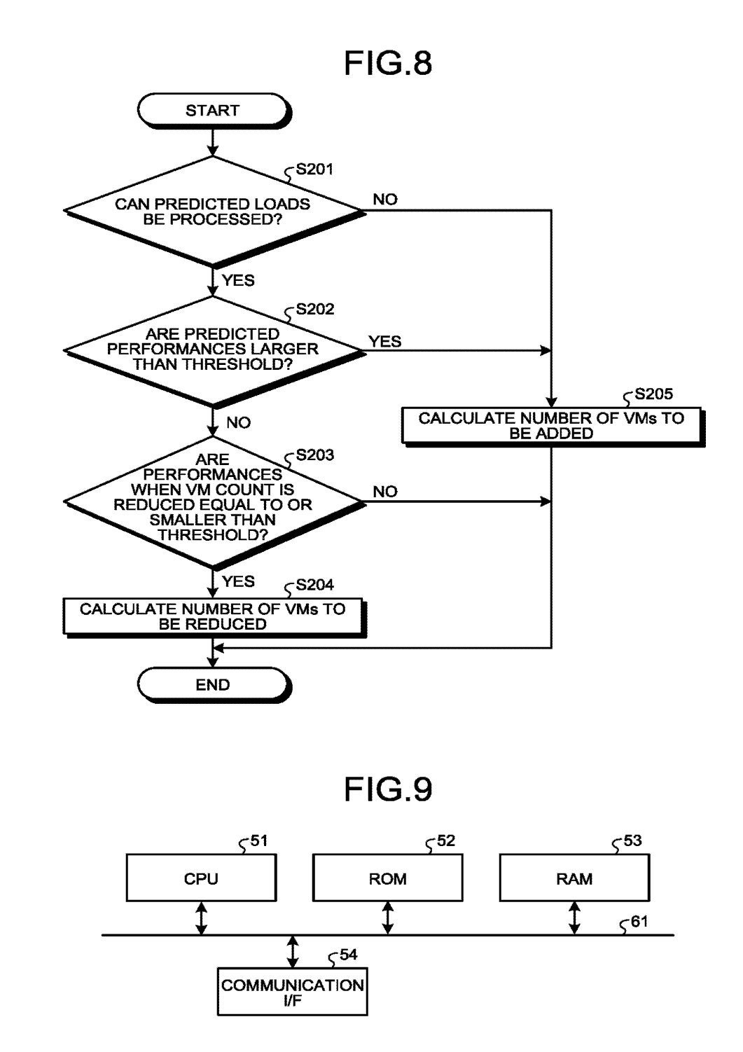

The following describes the calculation processing at step S108 in detail. FIG. 8 is a flowchart illustrating one example of the calculation processing for the VM count.

To begin with, the calculation unit 106 determines whether the predicted external loads can be processed by a current number of VMs (step S201). For example, the calculation unit 106 determines that the current VM group 210 cannot process the external loads if the formula (3) holds. When N is larger than one at the time of prediction, the calculation unit 106 may make a determination based on the number of times the formula (3) holds or the ratio thereof.

If the predicted external loads cannot be processed by the current VM group 210 (No at step S201), which means that the VM count is insufficient for the external loads to be processed, the calculation unit 106 uses the formula (4), for example, to calculate the VM count to be added (step S205).

If the predicted external loads can be processed by the current VM group 210 (Yes at step S201), the calculation unit 106 determines whether the predicted app performances (response times) are larger than a threshold (step S202). For example, the calculation unit 106 determines whether the formula (5) holds. When N is larger than one at the time of prediction, the calculation unit 106 may make a determination based on the number of times the formula (5) holds or the ratio thereof.

When an index that indicates a lower performance as the value thereof decreases unlike the response time is used as an app performance, the calculation unit 106 only needs to determine whether the value of this index is smaller than a threshold.

If the predicted app performances are larger than the threshold (Yes at step S202), which means that the VM count is insufficient for the external loads to be processed, the calculation unit 106 uses the formula (6), for example, to calculate the VM count to be added (step S205).

If the predicted app performances are equal to or smaller than the threshold (No at step S202), the calculation unit 106 determines whether the app performances when the VM count is reduced are equal to or smaller than the threshold (step S203). For example, the calculation unit 106 determines whether the formula (7) holds.

If the app performances when the VM count is reduced are equal to or smaller than the threshold (Yes at step S203), which means that the VM count is excessively large for the external load to be processed, the calculation unit 106 uses the formula (7), for example, to calculate the VM count to be reduced (step S204).

If the app performances when the VM count is reduced are larger than the threshold (No at step S203), the calculation unit 106 determines that the VM count does not have to be increased or reduced.

### MODIFICATION

The performance prediction unit 105 may notify the LB 201 about the prediction result of app performances of the respective VMs. Timing when an internal load is generated varies from one VM to another. In other words, timing when the performances decrease varies more than expected. Notifying the LB 201 about the prediction result of app performances of the respective VMs enables the LB 201 to calculate forwarding addresses of HTTP requests in consideration of difference in performance between the VMs. For example, for a VM the performance of which is predicted to significantly decrease due to an internal load, the LB 201 can determine that the number of HTTP requests to be forwarded needs to be reduced.

The present embodiment has been described in which a WebAS is exemplified as an application that is caused to operate on a VM, but the application used in the present embodiment is not limited to the WebAS. Similarly, the external load may be a load other than the HTTP request. Similarly, the index of performance of the application does not have to be the response time.

For example, the present embodiment may be applied to an application for collecting measured data transmitted from a sensor. In this case, the external load is the measured data (e.g., the number of pieces of measured data), for example.

In the above embodiment, a configuration has been described in which the management server 100 is positioned outside the public cloud 200. The management server 100 may be positioned inside the public cloud 200. At least one of the management server 100 and the LB 201 may operate on a VM on the public cloud 200.

As described above, in the server according to the present embodiment, the external load and the internal load are differentiated from each other and considered to predict the performance of the system, and based on the prediction result, resources in the virtual environment are controlled. This enables the performance of the system to be predicted more accurately. Consequently, the resources can be appropriately adjusted, and the performance of the system can be stabilized.

The following describes a hardware configuration of the server according to the present embodiment with reference to FIG. 9. FIG. 9 is an explanatory diagram illustrating an example of the hardware configuration of the server according to the present embodiment.

The server according to the present embodiment includes a control device such as a CPU 51, storage devices such as a read only memory (ROM) 52 and a RAM 53, a communication I/F 54 connected to a network and configured to communicate therethrough, and a bus 61 connecting these components.

A program to be executed by the server according to the present embodiment is provided in a manner preinstalled in the ROM 52, for example.

The program to be executed by the server according to the present embodiment may be configured so as to be stored as a file of an installable format or an executable format in a computer-readable recording medium such as a compact disc read only memory (CD-ROM), a flexible disk (FD), a compact disc recordable (CD-R), and a digital versatile disc (DVD) and to be provided as a computer program product.

Furthermore, the program to be executed by the server according to the present embodiment may be configured so as to be stored in a computer connected to a network such as the Internet and to be downloaded via the network to be provided. The program to be executed by the server according to the present embodiment may be configured so as to be provided or distributed via a network such as the Internet.

The program to be executed by the server according to the present embodiment can cause a computer to function as the respective units of the server described above. In this computer, the CPU 51 can read the program from a computer-readable storage medium onto a main storage unit to execute the program.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server configured to manage a resource in a virtual environment used by a service provided by an information processing system, the server comprising:
a load measurement unit configured to measure a load on the service;
a load prediction unit configured to predict a future load on the service, based on the measured load;
a performance measurement unit configured to measure a performance of the service;
a removing unit configured to remove influence due to the measured load from the measured performance;
a performance prediction unit configured to predict a future performance of the service, based on the performance from which the influence due to the load has been removed; and
a resource control unit configured to control the resource, based on the predicted load and the predicted performance.

2. The server according to claim 1, wherein
the resource is at least one of the number of virtual machines and the number of containers, and
the resource control unit controls at least one of the number of the virtual machines and the number of the containers, based on the predicted load and the predicted performance.

3. The server according to claim 1, wherein
the resource is a physical resource that is allocated to at least one of a virtual machine and a container, and
the resource control unit controls the physical resource that is allocated to at least one of the virtual machine and the container, based on the predicted load and the predicted performance.

4. The server according to claim 1, wherein
the load prediction unit predicts a load after a period of time required to start up the virtual environment has elapsed from current time, and
the performance prediction unit predicts a performance after the period of time required to start up the virtual environment has elapsed from the current time.

5. The server according to claim 1, wherein
the information processing system includes a load distributing unit configured to distribute a load on the virtual environment, and
the server further comprises a distribution control unit configured to transmit information on the resource controlled by the resource control unit to the load distributing unit.

6. A computer program product having a non-transitory computer readable medium including programmed instructions, wherein the instructions, when executed by a computer configured to manage a resource in a virtual environment used by a service provided by an information processing system, cause the computer to perform:
measuring a load on the service;
predicting a future load on the service, based on the measured load;
measuring a performance of the service;
removing influence due to the measured load from the measured performance;
predicting a future performance of the service, based on the performance from which the influence due to the load has been removed; and
controlling the resource, based on the predicted load and the predicted performance.

7. A communication system comprising:
an information processing system configured to provide a service using a virtual environment; and
a server configured to manage a resource in the virtual environment, wherein
the server comprising:
a load measurement unit configured to measure a load on the service;
a load prediction unit configured to predict a future load on the service, based on the measured load;
a performance measurement unit configured to measure a performance of the service;
a removing unit configured to remove influence due to the measured load from the measured performance;
a performance prediction unit configured to predict a future performance of the service, based on the performance from which the influence due to the load has been removed; and
a resource control unit configured to control the resource, based on the predicted load and the predicted performance.
